(19) United States
(12) Patent Application Publication
(10) Pub. No.: US 2004/0045318 A1
(43) Pub. Date: Mar. 11, 2004

(54) Method of making silica-titania extreme ultraviolet elements

(76) Inventors: Kenneth E. Hrdina, Horseheads, NY (US); Robert Sabia, Corning, NY (US)

Correspondence Address: CORNING INCORPORATED, SP-TI-3-1, CORNING, NY, 14831

(21) Appl. No.: 10/659,525

(22) Filed: Sep. 9, 2003

Related U.S. Application Data
(60) Provisional application No. 60/409,404, filed on Sep. 9, 2002.

(51) Int. Cl. C03B 19/12

(52) U.S. Cl. 65/17.2; 65/17.4

(57) ABSTRACT

Methods and apparatus for manufacturing titania-containing fused silica bodies and optical elements are described. The titania-containing fused silica bodies can be subsequently processed to make extreme ultraviolet optical elements. The methods and apparatus involve providing a sol including a titania-containing silica powder, forming the sol into a shaped gel and drying and heating the gel to a glass body.

### CROSS-REFERENCE TO RELATED APPLICATIONS

This application claims the priority under 35 U.S.C. §119(e) of U.S. Provisional Patent Application Serial No. 60/409,404, entitled “METHOD OF MAKING SILICA-TITANIA EXTREME ULTRAVIOLET ELEMENTS”, which is hereby incorporated herein by reference in its entirety.

### FIELD OF THE INVENTION

This invention relates to ultra low expansion extreme ultraviolet elements made from glasses including silica and titania. More particularly, the invention relates to methods and apparatus used for making such elements.

### BACKGROUND OF THE INVENTION

Ultra low expansion glasses and soft x-ray or extreme ultraviolet (EUV) lithographic elements made from silica and titania traditionally have been made by flame hydrolysis of organometallic precursors of silica and titania. The precursors form a titania-containing silica powder which is deposited in a collection vessel in a furnace and consolidated to form a titania-containing silica glass body. Ultra-low expansion silica-titania articles of glass are used in the manufacture of elements used in mirrors for telescopes used in space exploration and extreme ultraviolet or soft x-ray-based lithography. These lithography elements are used with extreme ultraviolet or soft x-ray radiation to illuminate, project and reduce pattern images that are utilized to form integrated circuit patterns. The use of extreme ultraviolet or soft x-ray radiation is beneficial in that smaller integrated circuit features can be achieved, however, the manipulation and direction of radiation in this wavelength range is difficult. Accordingly, use of wavelengths in the extreme ultraviolet or soft x-ray range, such as in the 1 nm to 70 nm range, has not been widely used in commercial applications. One of the limitations in this area has been the inability to economically manufacture mirror elements that can withstand exposure to such radiation while maintaining a stable and high quality circuit pattern image. Thus, there is a need for stable high quality glass lithographic elements for use with extreme soft x-ray radiation.

It would be advantageous to provide new methods and apparatus for manufacturing ultra low expansion glasses containing silica and titania. In particular, it would be desirable to provide methods and apparatus that are capable of producing such glass with decreased inhomogeneities in the body of the glass.

### SUMMARY OF THE INVENTION

The invention relates to methods and apparatus for producing titania-silica ultra low expansion glass bodies which are used as preforms for extreme ultraviolet optical or lithographic elements. Methods and apparatus are provided which are capable of producing ultra low expansion glass bodies and extreme ultraviolet optical or lithographic elements having decreased inhomogeneities. As used herein, the terms extreme ultraviolet (abbreviated as EUV) and soft x-ray will be used interchangeably to refer to short wavelengths of electromagnetic radiation between 1 nm and 70 nm. Presently, lithographic systems that utilize EUV radiation operate between 5 and 15 nm, and typically around 13 nm.

According to one embodiment of the invention, a method of manufacturing titania-containing silica glass is provided which can be used to make optical elements. In one embodiment a method of manufacturing an extreme ultraviolet optical element is provided that includes providing an aqueous sol including a solid phase of titania-containing silica powder and forming the sol into a titania-containing silica shaped gel having a homogenous distribution of titania. The method further includes drying the titania-containing silica gel to provide a dried titania-containing silica body and heating the titania-containing silica body to a temperature sufficient to form a glass body. In preferred embodiments, the titania-containing silica powder includes amorphous titania-containing silica powder. In highly preferred embodiments, the powder is provided by flame hydrolysis of organometallic precursors.

According to another embodiment of the invention, a titania-containing silica glass body has a length greater than about 10 cm, a width greater than about 10 cm, a titania concentration between about 6.5 wt % and about 7.5 wt %, and a CTE variation of less than about 1 ppb/° C.

According to the present invention, methods and apparatus are provided for the production of improved ultra low expansion titania-containing fused silica glass and extreme ultraviolet lithographic elements made therefrom. The methods and apparatus of the present invention enable the production ultra low expansion glass having decreased inhomogeneities in the body of the glass.

It is to be understood that both the foregoing general description and the following detailed description are exemplary and are intended to provide further explanation of the invention as claimed.

### BRIEF DESCRIPTION OF THE DRAWINGS

FIG. 1 is a schematic drawing of an apparatus for manufacturing titania-containing silica particles that can be used according to several embodiments.

### DETAILED DESCRIPTION

The invention provides methods and apparatus for manufacturing glass bodies having low thermal expansion and homogeneous titania concentrations. The methods and apparatus are particularly useful for the manufacture of extreme ultraviolet optical elements such as lithography substrates for both lithography masks and lithography mirror optics. The methods and apparatus avoid striae problems encountered during the formation of boules in conventional direct deposit flame hydrolysis boule process, particularly when the glass is ground and polished into a curved mirror reflective surface that cuts across the planar striae levels.

The invention further pertains to making thermally stable EUV lithography structure objects such as optical mirror lithography element substrate structures and reflective lithography mask element substrate structures. PCT patent publication WO 01/08163, entitled EUV SOFT X-RAY PROJECTION LITHOGRAPHIC METHOD SYSTEM AND LITHOGRAPHY ELEMENTS commonly assigned to CORNING INCORPORATED and naming Davis et al. as inventors and WO 01/07967, entitled EUV SOFT X-RAY PROJECTION LITHOGRAPHIC METHOD AND MASK DEVICES commonly assigned to CORNING INCORPORATED and naming Davis et al. as inventors, the contents of which are hereby incorporated by reference discloses EUV lithography mirror element and mask structures.

According to the present invention, methods and apparatus are provided for the production ultra low expansion titania-silica glass elements. In overview, the titania-silica glass elements are made by the sol-gel process. According to certain embodiments, the method includes providing an aqueous sol including a solid phase of titania-containing silica powder and forming the sol into a titania-containing silica shaped gel having a homogenous distribution of titania. Thereafter, the shaped gel is dried to provide a dried titania-containing silica body, and the dried body is then heated to a temperature sufficient to form a glass body.

One particular example of a process according to some embodiments of the invention involves making an extreme ultraviolet optical element by providing an aqueous sol including a mixture of a solid phase of titania doped silica powder having a concentration of titania between about 3 weight percent and 10 weight percent, a titanium containing alkoxide, a silicon containing alkoxide, and water. In some embodiments, the sol is formed into a titania-containing silica shaped gel having a homogenous distribution of titania. According to certain embodiments, the gel is then dried to provide a dried titania-containing silica body by exchanging said water with an exchange solvent having a critical value temperature and a critical value pressure. The dried body can be further dried by hypercritical drying at a temperature and a pressure higher than said exchange solvent critical value temperature and pressure. After drying, the titania-containing silica body is heated to a temperature exceeding 1600° C. to form an extreme ultraviolet optical element glass body having a homogeneous CTE in the range of about +30 ppb/° C. to −30 ppb/° C. between 20° C. and 35° C. and a titania concentration between about 3 weight percent and 10 weight percent. In certain embodiments, the titanium containing alkoxide is titanium isopropoxide and the silicon containing alkoxide is tetraethylorthosilicate. In preferred embodiments, the homogeneous CTE has a variation of less than about 10 ppb/° C.

The sol-gel process involves the development of inorganic networks through the formation of a suspension of particles or a sol and gelation of the sol to form a network in a continuous liquid phase or a gel. The precursors for making sol include a metal or metalloid element surrounded by various reactive ligands. Metal alkoxides are most popular because they react readily with water. The most widely used metal alkoxides are the alkoxysilanes, such as tetramethoxysilane (TMOS) and tetraethoxysilane (TEOS). At the functional group level, three reactions are generally used to describe the sol-gel process: hydrolysis, alcohol condensation, and water condensation. Hydrolysis involves the reaction of a metal alkoxide with water to form a metal hydroxide. A condensation reaction occurs when two metal hydroxides (M—OH +HO—M) combine to form a metal oxide species (M—O—M). The reaction forms a water molecule. As used herein, a sol refers to a solution of various reactants that are undergoing hydrolysis and condensation reactions. The molecular weight of the oxide species produced continuously increases. As these species grow, they may begin to link together in a three-dimensional network. A gel forms when the network of linked oxide particles spans the container holding the sol. Prior to drying, the gel comprises a solid part and a liquid part. The solid part includes a three-dimensional network of linked oxide particles. The liquid part surrounds the free spaces surrounding the solid part. The gel is then dried by solvent exchange, supercritical drying, or a combination of these. During drying, the liquid within the gel is removed, leaving only the linked particle network.

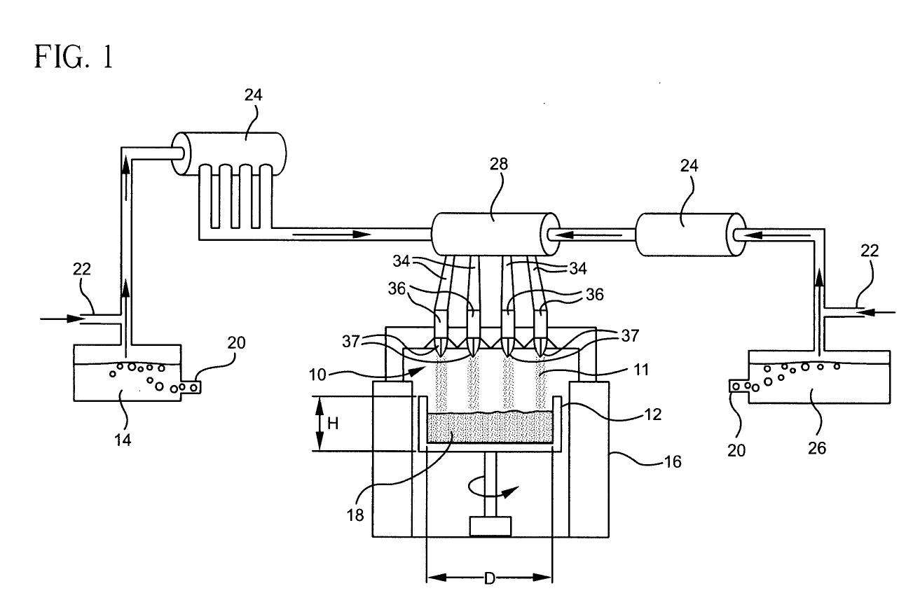

According to certain embodiments of the present invention, the titania-containing silica particles are preferably amorphous titania-containing silica particles made by the flame hydrolysis process. As shown in FIG. 1, a conventional apparatus for the manufacture of titania-containing silica particles or powders includes high purity silicon-containing feedstock or precursor 14 and high purity titanium-containing feedstock or precursor 26. The feedstock or precursor materials are typically siloxanes, alkoxides and tetrachlorides containing titanium or silicon. One particular commonly used silicon-containing feedstock material is octamethylcyclotetrasiloxane, and one particular commonly used titanium-containing feedstock material is titanium isopropoxide. An inert bubbler gas 20 such as nitrogen is bubbled through feedstocks 14 and 26, to produce mixtures containing the feedstock vapors and carrier gas. An inert carrier gas 22 such as nitrogen is combined with the silicon feedstock vapor and bubbler gas mixture and with the titanium feedstock vapor and bubbler gas mixture to prevent saturation and to deliver the feedstock materials 14, 26 to the conversion site 10 through distribution systems 24 and manifold 28. The silicon feedstock and vapor and titanium feedstock and vapor are mixed in the manifold 28 to form a homogeneous, vaporous, titania-containing silica glass precursor mixture which is delivered through conduits 34 to conversion site burners 36 mounted in the upper portion 38 of the furnace 16. The burners 36 produce burner flames 37. Conversion site burner flames 37 are formed with a fuel and oxygen mixture such as methane mixed with hydrogen and/or oxygen, which combusts, oxidizes and converts the feedstocks at temperatures greater than about 1600° C. into soot 11. The temperature of the conduits 34 and the feedstocks contained in the conduits are typically controlled and monitored in minimize the possibility of reactions prior to the flames 37.

The feedstocks are delivered to a conversion site 10, where they are converted into titania-containing silica soot particles or powder 11. In a typical glass manufacturing process not related to the present invention, the soot 11 is deposited in a revolving collection cup 12 located in a refractory furnace 16 typically made from zircon and onto the upper glass surface of a hot titania-silica glass body 18 inside the furnace 16. The soot particles 11 consolidate into a titania-containing high purity silica glass body. However, according to the present invention, instead of collecting and consolidating the soot particles in a refractory furnace as shown in FIG. 1, the soot particles are collected in a container other than a furnace and utilized in a sol gel manufacturing process described further below.

The foregoing example of a flame hydrolysis system is not intended to limit the invention as to the source of silica soot used in various embodiments of the invention. The various embodiments of the invention preferably have sufficient purity, preferred chemical composition and preferred particle size of the titania-containing silica soot. Other systems and methods for generating titania-silica glass particles may be used in certain embodiments of the invention. Preferably, the titania-containing silica powder is an amorphous powder wherein the titania and silica are mixed on an atomic level. The titanium content of the silica soot can be adjusted to a dopant level in a range of about zero to ten percent by weight. Typically, the soot particle size will be in a range of about 0.005 microns to 0.4 microns, with an average particle size of about 0.2 microns.

The feedstock or precursor materials for generating silica and titania particles can include siloxanes, alkoxides and tetrachlorides containing titanium or silicon. One particular example of a silicon-containing precursor material includes octamethylcyclotetrasiloxane, and one example of a titanium-containing feedstock material is titanium isopropoxide. Other silicon-containing and titanium materials that can be used include silicon tetrachloride and titanium tetrachloride. The system for delivering the vaporous precursor containing gases shown in FIG. 1 can be used to generate particles via flame hydrolysis in burners 120 and 122. Therefore, an inert bubbler gas such as nitrogen is separately bubbled through silicon-containing and titanium-containing precursors to produce mixtures containing the feedstock vapors and carrier gas. An inert carrier gas such as nitrogen is combined with the silicon feedstock vapor and bubbler gas mixture and with the titanium feedstock vapor and bubbler gas mixture to prevent saturation and to deliver the precursor materials to the burners.

In certain preferred embodiments, powders, ultra low expansion titania-silica glass bodies and EUV optical elements are provided having a homogeneous titania level in the range from 3 weight percent TiO₂ to about 10 weight percent TiO₂ and a homogeneous CTE in the range of about +30 ppb/° C. to −30 ppb/° C. between about 20° C. and 35° C., preferably in the range of about +20 ppb/° C. to −20 ppb/° C. between about 20° C. and 35° C. More preferably, the powder, the glass and optical elements have a homogeneous titania silica glass titania level in the range from 6 weight percent TiO₂ to about 9 weight percent TiO₂ and a homogeneous CTE in the range of about +10 ppb/° C. to −10 ppb/° C. between about 20° and 35° C., and most preferably a CTE in the range of about +5 ppb/° C. to −5 ppb/° C. between about 20° C. and 25° C., with the CTE having a variation in coefficient of thermal expansion less than 5 ppb/° C. Preferably, the powder particles and the titania-containing silica glass have a titania level in the range from about 3 weight percent titania to about 9 weight percent titania, and more preferably between about 6 weight percent TiO₂ and 8 weight percent TiO₂. Even more preferably, the powder, the consolidated glass and the EUV optical substrate have a titania level in the range from about 6 weight percent TiO₂ to 8 weight percent TiO₂. Most preferably, the level of titania contained in the silica powder particles and the silica-titania glass is between about 6.8 and 7.5 weight percent TiO₂.

In preferred embodiments, CTE uniformity or variation within the article is less than about 10 ppb/° C. and preferably less than about 5 ppb/° C. or even less than about 1 ppb/° C. The low expansion articles can be used for extreme ultraviolet lithographic (EUVL) applications including, but not limited to, photomask substrates, reflective optics, condenser optics, stages and in some instances, for transmission purposes where index homogeneity should be less than about 25 ppm and preferably less than about 5 ppm or even less than about 1 ppm. The process incorporates titania-containing silica powder in sol-gel type forming operations. One advantage of the sol-gel processes over conventional flame hydrolysis processes includes improvements in CTE homogeneity and minimization of striae within the sol-gel-derived glasses. According to certain embodiments, the invention employs the use of a solvent exchange process and supercritical drying operation to achieve large size gelled specimens, greater than 10 cm in diameter and greater than 10 cm in length. According to certain embodiments, gelled bodies formed by sol-gel processes are dried and then consolidated in a helium or vacuum atmosphere as a means of minimizing voids. Additionally, in certain embodiments, it is desirable to avoid heavily reducing atmospheres typically encountered in graphite furnaces to minimize the reduction of titanium 4+species to titanium 3+species. Therefore it is desirable to consolidate the bodies in oxidizing furnace such as an induction coupled platinum heated furnace, operating in air, vacuum or helium. Certain embodiments of the invention involve heating above the melting point of crystallites, which is typically greater than 1600° C.

Thus, according to certain embodiments of the present invention, titania-containing silica articles are manufactured in which the glass is homogeneous in both the mid and low frequency ranges (mm and cm scale respectively). High levels of homogeneity are required for use of the material in areas such as EUVL photomask substrates and optics for the EUVL stepper cameras. Improved homogeneity is also desired for ultra low expansion (ULE) mirrors made from titania-containing silica glass. Larger size glass blanks are desired for these products, with expected size ranging from 100 mm up to 700 mm in diameter and thickness ranging from 6 mm up to 150 mm. Photomasks are currently 152 mm×152 mm×6.32 mm in thickness.

Typically, one of the biggest challenges of making glass articles from powders involves the manufacture of large size specimens, which as used herein refers to articles or bodies of glass that are greater than about 10 cm in diameter. According to certain embodiments of the invention, a method of forming a sol entails making a solution including an acid and titania-containing silica power mixed in a slurry. According to these embodiments, a second solution or slurry is made by mixing a base with titania-containing silica powder. The two slurries or solutions are then mixed, and the mixed slurries then gel in a controlled manner. Preferably the slurries are formed into a shaped gel, for example, in a cylindrical shape. The formed gel then undergoes further processing, including a solvent exchange, supercritical drying operation, and densification procedures to form glass articles. Preferably, an amorphous flame hydrolyzed titania-containing silica powder is used in making the slurries. According to certain embodiments, instead of heating to only densification temperatures, the formed glass article could be heated to temperatures exceeding the melting point of any crystallites that may be present. Temperatures exceeding about 1600° C. and preferably exceeding about 1650° C. should be sufficient to melt crystallites in ULE glass compositions. These high temperatures serve to melt out crystalline phases and also allow time for gases to escape such as helium or hydrogen permeation through the glass structure. The viscosity of the glass at high temperatures also is low enough to allow collapse of vacant seeds in a few seconds or minutes that may be kinetically limited at lower temperatures.

It may take days or weeks to dry or exchange solvents in larger shaped gels having diameters exceeding 10 centimeters. Manufacturing time may be limited in diameter by the time needed for the system to undergo solvent exchange or drying. However, the time to manufacture is roughly independent of the length of the cylinders. Therefore, according to certain embodiments of the invention, larger quantities of glass can be made by increasing the lengths of the cylinders with almost no added time to the manufacturing process. After the shaped gel has been dried and consolidated into a glass body, the smaller diameter cylinder can be heated and flowed out into a larger diameter cylinder. This will allow the production of glass in a reasonable time, which then could be flowed out to desired diameters needed for EUVL or other applications.

According to certain embodiments, a sol is formed by mixing titania-containing silica powders with alkoxides containing silicon and titanium. A gel is formed by hydrolysis, and in certain preferred embodiments, the titanium and silicon ratios in the powder are approximately equivalent to the titanium and silicon ratios in the alkoxides. Preferably, amorphous titania-containing silica powders are employed. Crystalline silica and titania powders serve to inhibit homogeneous glass formation since interdiffusion of the two species is extremely slow at ordinary processing temperatures between about 1400° C. and 2000° C. Therefore, amorphous materials are preferred to form glass bodies having higher homogeneity.

Formation of the sol and shaping of the gel typically occurs in a container or a mold as is known in the art. Preferably, the molds or containers should be made of materials that minimize sticking of the gels to the container or molds, such as, for example, Teflon®, polypropylene or polished surfaces of other materials.

After formation of the gel, the formed gel is preferably dried, preferably in a two step process first involving solvent exchange according to procedures known in the art, and then supercritical or hypercritical drying. Examples of appropriate solvents for solvent exchange include, but are not limited to, ethanol, methanol and liquid carbon dioxide. It may be desirable to perform the drawing in a chamber under controlled temperature and pressure, such as in an autoclave. Supercritical drying avoids the liquid-gas interface and thus minimizes capillary forces, which can lead to cracks in the body. Hypercritical or supercritical drying involves drying at temperatures and pressures higher than the critical values of the solvent present in the gel. According to certain embodiments, after loosely-held water and organic reagents are removed from the body by solvent exchange, the gel is normally subjected to a further drying or pre-consolidation treatment to remove bound water and organic constituents. In certain embodiments, temperatures above about 1000° C. are suitable for this purpose with a preferred temperature range being about 1000-1400° C. Heating times of one hour or more at these temperatures is normally sufficient to substantially remove bound water and organics from the pore structure.

In carrying out this pre-consolidation treatment according to certain embodiments, relatively slow heating of the porous body is employed to guard against overly rapid removal of residual water from the pore structure. If fast heating is employed, cracking of the porous body can readily occur. The preferred practice is to heat the porous body at a rate not exceeding about 300° C. per hour to the peak drying temperature employed. In certain preferred embodiments, the body should be heated at a rate of about 1° C. per minute up to temperatures of about 400° C. to 600° C. As an alternative, the structure can undergo heat treatment in this step with a halide drying agent such as chlorine of fluorine containing gases or mixtures thereof. A chlorine/helium mixture or a chlorine/helium/ oxygen mixture may be introduced into the furnace to remove water if a dried titania doped glass is desired. An example of one such treatment involves the introduction of a chlorine/helium mixture at 800° C. A vacuum may aid in gas penetration to article center. Next, the material could be heated in vacuum or helium gas as a preferred means of avoiding trapping of gases up to consolidation temperatures between about 1100° C. and 1500° C. Helium permeates the open silica structure and thus minimizes void formation. Following this treatment, the porous dried gel may be cooled to room temperature and examined for cracks or other defects.

The dried gel produced as described is finally consolidated to transparent, homogeneous glass by further firing. Consolidation can be carried out conveniently at temperatures in the range of about 1350°-1700° C. within time periods of about 0.5 to 4 hours, depending upon the size of the article. As in the case of drying, heating of the article to consolidation temperatures should be relatively uniform, since different consolidation rates can result in shape distortion and/or cracking. Preferably, the parts are be heated to temperatures exceeding the melting point any crystallites in the glass body which may have formed during processing, and typically temperatures exceeding about 1600° C. are sufficient to achieve this purpose.

To insure full consolidation and the absence of any entrapped seeds or bubbles in the glass, it may be desirable to carry out the consolidation process in an atmosphere of high diffusibility, such as helium. In this way, complete pore closure is encouraged and the entrapment of residual seeds in the glass is minimized. In some cases, the maintenance of slightly oxidizing conditions in the consolidation atmosphere may also be useful, to avoid undue reduction of Ti⁺⁴ ions to Ti⁺³. In certain embodiments, it may be desirable to hot isostatically press the parts to ensure the absence of any entrapped bubbles or seeds in the glass.

In certain preferred manufacturing process, longer cylinders (e.g., exceeding 10 centimeters) are desired which then allow more material to be processed without significantly increasing the time needed to exchange the solvents and time needed to hypercritically dry the gels. Solvent exchange and hypercritically drying will be inversely related to the square of the diameter of the gel, so increased diameters may require significant increased time, while increased lengths should have no or little impact on the time needed to process the part.

According to certain embodiments, striae in finished parts should be less than 0.1 MPa peak to valley. Inclusion levels should be such that inclusions greater than 100 microns being are present at less than 0.01 inclusions/cm³ within a given article. Impurity levels should be less than 10-ppm alkali or alkaline earths or iron.

The invention will now be further illustrated by the following non-limiting Example.

### EXAMPLE

A titania-containing silica powder was made using the flame hydrolysis method described hereinabove. The titania-containing silica powder had a titania concentration of 7.19 wt %, and a surface area of 25 m ²/g. A 2190 g sample of the titania-containing silica powder was mixed with 194 g of 25 wt % aqueous tetramethylammonium hydroxide and 1266 g of deionized water. The mixture was rolled overnight to form a slurry, to which was added 55.6 g 2-chloro-1-propanol. The slurry was degassed in a vacuum, poured into a STYROFOAM container (about 230 mm×230 mm×50 mm), and allowed to dry for 1 week at room temperature followed by a 48 hour ramp to 120 C., thereby forming a plate-shaped gel. The dried gel was heated slowly to 800° C. in air in order to remove organics, then heated to 1410° C. in helium at 4° C./min to consolidate the gel into a glass plate. The glass plate was given a final heat treatment at 1600° C. to collapse any seeds present. The glass plate so formed had a CTE uniformity of 0.25 ppm/° C. at room temperature.

It will be apparent to those skilled in the art that various modifications and variations can be made to the present invention without departing from the spirit or scope of the invention. Thus, it is intended that the present invention covers modifications and variations of this invention provided they come within the scope of the appended claims and their equivalents.

What is claimed is:

1. A method of making an extreme ultraviolet optical element comprising:
providing an aqueous sol including a solid phase of titania-containing silica powder;
forming the sol into a titania-containing silica shaped gel having a homogenous distribution of titania;
drying the titania-containing silica gel to provide a dried titania-containing silica body; and
heating the titania-containing silica body to a temperature sufficient to form a glass body.

2. The method of claim 1, wherein the titania-containing silica powder includes amorphous titania-containing silica powder.

3. The method of claim 2, wherein the amorphous titania-containing silica powder is formed by flame hydrolysis of organometallic precursors.

4. The method of claim 1, wherein the concentration of titania in the silica powder is between about 3 weight percent and 10 weight percent.

5. The method of claim 4, wherein the concentration of titania in the silica powder is between about 6.5 weight percent and 7.5 weight percent.

6. The method of claim 4, wherein the extreme ultraviolet optical element has a homogeneous CTE in the range of about +30 ppb/° C. to −30 ppb/° C. between 20° C. and 35° C.

7. The method of claim 6, wherein the extreme ultraviolet optical element has a homogeneous CTE in the range of about +10 ppb/° C. to −10 ppb/° C. between 20° C. and 35° C.

8. The method of claim 7, wherein the homogeneous CTE has a variation of less than about 10 ppb/° C.

9. The method of claim 6, wherein the glass body has a diameter of at least about 10 centimeters and a length of at least about 10 centimeters.

10. The method of claim 4, wherein the heating is performed at a temperature sufficient to melt crystalline phases.

11. The method of claim 10, wherein the heating is performed at a temperature exceeding 1600° C.

12. The method of claim 1, wherein providing a sol includes mixing titania-containing silica powder with alkoxides containing titanium and silicon.

13. The method of claim 12, wherein the ratio of titanium to silicon in the powder is approximately equivalent to the ratio of titanium to silicon in the alkoxides.

14. The method of claim 1, wherein providing a sol includes mixing a first solution of titania-containing silica powder in an aqueous acid with a second solution of titania-containing silica powder in an aqueous base.

15. The method of claim 1, wherein drying the gel includes solvent exchange.

16. The method of claim 15, wherein drying the gel further includes hypercritical drying at temperatures and pressures higher than the critical values of the solvent.

17. The method of claim 16, further including heating the gel in the presence of a halide gas.

18. The method of claim 16, further including heating the gel under vacuum pressure.

19. The method of claim 1, further including finishing the body into an optical element selected from the group consisting of a photomask substrate, an extreme ultraviolet optical element, and an extreme ultraviolet condenser lens.

20. A method of making an extreme ultraviolet optical element comprising:
providing an aqueous sol including a mixture of a solid phase of titania doped silica powder having a concentration of titania between about 3 weight percent and 10 weight percent, a titanium containing alkoxide, a silicon containing alkoxide, and water;
forming the sol into a titania-containing silica shaped gel having a homogenous distribution of titania;
drying the titania-containing silica gel to provide a dried titania-containing silica body by exchanging said water with an exchange solvent having a critical value temperature and a critical value pressure and then hypercritical drying at a temperature and a pressure higher than said exchange solvent critical value temperature and pressure; and
heating the titania-containing silica body to a temperature exceeding 1600° C. to form an extreme ultraviolet optical element glass body having a homogeneous CTE in the range of about +30 ppb/°C. to −30 ppb/° C. between 20° C. and 35° C. and a titania concentration between about 3 weight percent and 10 weight percent.

21. The method of claim 20, wherein the homogeneous CTE has a variation of less than about 10 ppb/° C.

22. A titania-containing silica glass body having a length greater than about 10 cm, a width greater than about 10 cm, a titania concentration between about 6.5 wt % and about 7.5 wt %, and a CTE variation of less than about 1 ppb/° C.
